(19) United States
(12) Patent Application Publication
(10) Pub. No.: US 2016/0140186 A1
(43) Pub. Date: May 19, 2016

(54) Identifying Subject Matter Experts

(71) Applicant: Manfred Langen, München (DE)

(72) Inventor: Manfred Langen, München (DE)

(21) Appl. No.: 14/541,760

(22) Filed: Nov. 14, 2014

(51) Int. Cl. G06F 17/30

(52) U.S. Cl. CPC G06F 17/30554; G06F 17/3053; G06F 17/30702; G06F 17/3069; G06F 17/30663

(57) ABSTRACT

Methods of identifying subject matter experts are disclosed. In one embodiment, the method includes receiving a search profile corresponding to a particular subject matter. Resources including content describing the particular subject matter are retrieved. One or more potential subject matter experts associated with the resources are identified. An expert score representing an estimated level of expertise for each potential subject matter expert is calculated. By retrieving one or more social media repositories, an impact rating for each potential subject matter expert is calculated with regard to the particular subject matter. The potential subject matter experts are subsequently ranked in dependence upon the expert score and in dependence of the impact rating assigned to a potential subject matter expert. The potential subject matter experts are eventually returned in the order of this ranking.

### TECHNICAL FIELD

The disclosed embodiments relate to methods for identifying subject matter experts.

### BACKGROUND

Forums and bulletin boards provide an abundance of information on various topics and may be used by individuals to solicit and provide information on a variety of topics.

In addition to finding information on a particular subject, there is also a frequent need to identify subject matter experts, e.g., authorities on particular subjects. For example, research paper writers may wish to find articles of those eminent in particular fields, and further, may wish to discover some degree of information about the relative eminence of one author compared with another. As a further example, those seeking to employ expert witnesses may wish to do so at least partially based on the extent to which potential expert witnesses have published articles, books, papers, etc.

In certain forums, individuals may proclaim their expertise in an area in order to be identified as a subject matter expert. This allows for addressing topics within respective areas of subject matter expertise. Similarly, self-proclaimed or recognized experts may receive technical inquiries within their field of expertise from other individuals. Both types of expressing expertise however demonstrate only that an individual has knowledge on particular subjects, not whether others view such person as an expert in a particular subject matter.

### SUMMARY AND DESCRIPTION

The scope of the present invention is defined solely by the appended claims and is not affected to any degree by the statements within this summary. The present embodiments may obviate one or more of the drawbacks or limitations in the related art.

Currently employed methods of identifying subject matter experts are merely based on an expertise, or quantified: an expert score, of an individual. Accordingly, there is a need in the art for a method of identifying persons adept in a particular subject matter that at least partially considers a reputation of the person with regard to the particular subject matter on the part of third parties.

Systems and methods in accordance with various embodiments are provided for identifying a subject matter expert.

In one embodiment, a computer-implemented method of identifying subject matter experts is disclosed. The method includes the reception of a search profile corresponding to a particular subject matter. In dependence upon the search profile, resources including content describing the particular subject matter are retrieved. One or more potential subject matter experts associated with the resources are identified in a further act. An expert score representing an estimated level of expertise for each potential subject matter expert is calculated for each of the potential subject matter experts in dependence upon the particular subject matter. By retrieving one or more social media repositories, an impact rating for each potential subject matter expert is calculated with regard to the particular subject matter. The potential subject matter experts are subsequently ranked in dependence upon the expert score and in dependence of the impact rating assigned to a potential subject matter expert. The potential subject matter experts are eventually returned in the order of this ranking.

According to an embodiment, the search profile is formed by a weighted collection of topics and/or concepts. The usage of concepts advantageously supports a processing of the suggested method based on ontologies, triplestores, or other kinds of structured resources.

According to an embodiment, the search profile is formed by a search vector. The concept of vectors advantageously allows a determination of a cosine similarity as a distance or similarity metric. The cosine distance is also advantageous calculating the expert score and the impact rating by using textual vectors or a weighted list of tags, or calculating a difference between a search profile vector and a knowledge profile, (e.g., a personal tag cloud assigned to an individual).

According to an embodiment, the retrieval of resources includes matching the search vector with one or more vectors of a knowledge profile including the particular subject matter.

According to an embodiment, the impact rating includes a resonance or a reach of a potential subject matter expert within social media repositories. In an alternative embodiment, the impact rating includes both resonance and reach of a potential subject matter expert within social media repositories.

According to an embodiment, the resonance of a potential subject matter expert within social media repositories is determined by assessing comments in response to the potential subject matter expert.

According to an embodiment, the resonance of a potential subject matter expert within social media repositories is determined by determining an average value of ratings of the potential subject matter expert.

According to an embodiment, the resonance of a potential subject matter expert within social media repositories is determined by determining a number of followers of the potential subject matter expert.

According to an embodiment, the resonance of a potential subject matter the resonance of a potential subject matter expert is accessorily weighted by a relationship of users assessing contents of the subject matter expert, the relationship being sociometrically derived of the social media repositories.

According to an embodiment, the reach of a potential subject matter expert within social media repositories is determined by determining a retrieval count of contents published by the potential subject matter expert.

According to an embodiment, the reach of a potential subject matter expert within social media repositories is determined by determining a count of re-posts including contents published by the potential subject matter expert.

According to an embodiment, a first adjustable weight factor for the expert score and a second adjustable weight factor for the impact rating are applied for ranking the potential subject matter experts.

According to an embodiment, a computer program product is disclosed, the computer program product including program code stored on a non-transitory computer-readable storage medium, the program code, when executed on a computer, is configured to:

(1) receive a search profile corresponding to a particular subject matter; (2) retrieve, in one or more information repositories, in dependence upon the search profile, one or more resources including content describing the particular subject matter; (3) identify one or more potential subject matter experts associated with the resources; (4) calculate, for each of the potential subject matter experts, in dependence upon the particular subject matter, an expert score representing an estimated level of expertise for each potential subject matter expert; (5) calculate, by retrieving one or more social media repositories, an impact rating for each potential subject matter expert with regard to the particular subject matter; (6) rank the potential subject matter experts in dependence upon the expert score and in dependence of the impact rating assigned to a potential subject matter expert; and (7) return, as one or more search results, the potential subject matter experts in order of the ranking.

### BRIEF DESCRIPTION OF THE DRAWINGS

For a better understanding of the embodiments described herein and to depict how the embodiments may be carried into effect, reference will now be made, by way of example only, to the accompanying drawings that depict at least one exemplary embodiment.

FIG. 1 depicts a flow diagram of a method for identifying subject matter experts.

FIG. 2 depicts a block diagram that is used during for functional description of a ranking of potential subject matter experts.

### DETAILED DESCRIPTION

Currently employed methods of identifying subject matter experts have considerable drawbacks in that these methods are merely analyzing the technical expertise of an individual, whereas categories like the relevancy, reputation, and resonance of potential subject matter experts are neglected.

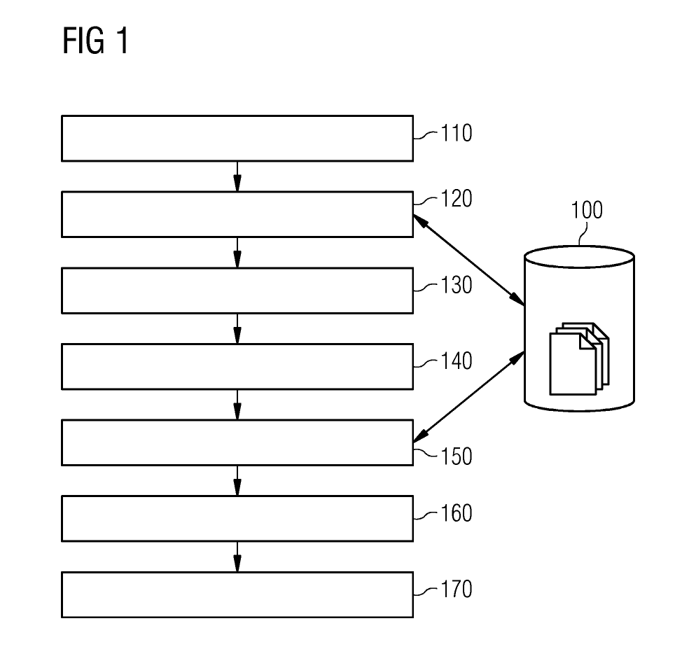

FIG. 1 depicts a flow diagram of an exemplary method according to an embodiment for identifying subject matter experts that is configured to consider a reputation of an individual with regard to the particular subject matter. The exemplary method depicted by FIG. 1 may be executed by a subject matter expert search engine. The subject matter expert search engine may be provided by a module of computer program or by a distributed web process including software instructions that may operate for identifying subject matter experts in accordance with the embodiments.

In act 110, a search profile corresponding to a particular subject matter is received by an interface of the subject matter expert search engine. The search profile is received from an input by a user or by a service including a service that is remotely connected to the subject matter expert search engine for data communications purposes. A search profile includes search requests of all kinds, including textual inputs, software-defined profiles, data base entries, weighted collection of topics weighted collection of concepts, search vector, or a combination thereof.

In act 120, resources including content describing the particular subject matter in dependence upon the search profile are retrieved in one or more information repositories 100. Examples of information repositories include web servers, databases, file systems, and so on as will occur to readers of skill in the art. Resources include structured or unstructured contents such as user generated content within bulletin boards, forums, social networks, information compendia, publications, etc. Further resources include metadata such as keywords, tags, publications, or user generated content (e.g. postings, comments, etc.). The resources are aggregated, semantically interpreted, and associated with a related subject matter expert identified by an additional act. The semantically interpreted resources are optionally expressed by a weighted vector including topics and/or concepts describing a knowledge profile of a potential subject matter expert.

In act 130, one or more potential subject matter experts associated with the resources are identified.

In act 140, an expert score representing an estimated level of expertise for each potential subject matter expert is calculated in dependence upon the particular subject matter. According to an embodiment, the expert score is based on a determination of a cosine similarity as a distance or similarity metric between the knowledge profile vector and the search profile vector. The outcome is a first metric expressing a knowledge or expertise match.

In certain embodiments, a second metric is determined and taken into account for the task of finding a subject matter expert.

In act 150, an impact rating for each potential subject matter expert with regard to the particular subject matter is calculated by retrieving one or more social media repositories 100. The social media repositories 100 may be identical with, attached to, or related with the information repositories 100 mentioned above.

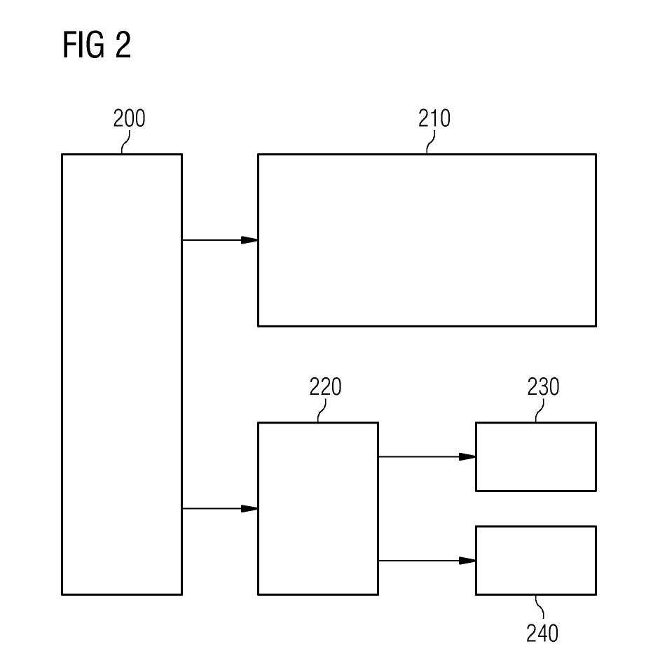

Turning now to FIG. 2, a result 200 of said two metrics includes a first metric that is referred to as relevance 210 and an impact rating 220 as a second metric considering content of a subject matter expert that may be published in social networks with relevance 210 for the search profile. The impact rating 220 expresses a “digital influence” of a potential subject matter expert by an acquired reputation including a resonance 230 and/or a reach 240 of a potential subject matter expert within social media repositories. The resonance 230 of a potential subject matter expert within social media repositories is determined by assessing comments in response to the potential subject matter expert, by determining an average value of ratings, and/or by determining a number of followers of the potential subject matter expert. This resonance is optionally or accessorily weighted by a relationship of users assessing contents of the subject matter expert whereby the relationship is sociometrically derived of the social media repositories. Credits by friends, followers, or colleagues may result in a decreased weighting under the assumption that a closer relationship affects a favorable consideration. The reach 240 of a potential subject matter expert within social media repositories is determined by determining a retrieval count of contents published by the potential subject matter expert, and/or by determining a count of re-posts including contents published by the potential subject matter expert.

Turning back to FIG. 1, the method is followed by act 160, by which a ranking of potential subject matter experts is executed. The ranking is carried out in dependence of the expert score and the impact rating assigned to a potential subject matter expert, thereby considering both metrics.

In act 170, the potential subject matter experts are returned as search results in order of the ranking.

According to an embodiment, the subject matter expert search engine is integrated within a corporate knowledge networking tool making use of tag profiles expressing a spectrum of competences assigned to a user of the tool. This tag profile is altered with any interaction of a user within the knowledge networking tool. A subject matter area is likewise described by a weighted list of tags. Using a cosine distance of associated textual vectors an association between a subject matter and a subject matter expert is made. The result is a ranked list of potential subject matter expert.

Each potential subject matter expert in the ranked list is now assessed in terms of resonance and reach of resources published by the respective individual of said list. Only those resources are assessed that are similar (e.g., not cosine-distant) with the particular subject matter. In other words, an impact rating for each potential subject matter expert is executed with regard to the particular subject matter.

The resources are assessed by resonance (e.g., number of comments and affirmations or “likes”) and reach (e.g., number of views). The respective counts are weighted in dependence upon the expert score and totalized. The outcome is a re-ordered list of subject matter experts that considers the expert score and the impact rating or digital influence of a subject matter expert.

The instructions for implementing processes or methods described herein may be provided on non-transitory computer-readable storage media or memories, such as a cache, buffer, RAM, FLASH, removable media, hard drive, or other computer readable storage media. A processor performs or executes the instructions to train and/or apply a trained model for controlling a system. Computer readable storage media include various types of volatile and non-volatile storage media. The functions, acts, or tasks illustrated in the figures or described herein may be executed in response to one or more sets of instructions stored in or on computer readable storage media. The functions, acts or tasks may be independent of the particular type of instruction set, storage media, processor or processing strategy and may be performed by software, hardware, integrated circuits, firmware, micro code and the like, operating alone or in combination. Likewise, processing strategies may include multiprocessing, multitasking, parallel processing and the like.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method of identifying subject matter experts, a subject matter expert comprising a person adept in a particular subject matter, the method comprising:
receiving a search profile corresponding to a particular subject matter;
retrieving, in one or more information repositories, in dependence upon the search profile, one or more resources comprising content describing the particular subject matter;
identifying one or more potential subject matter experts associated with the resources;
calculating, for each potential subject matter expert, in dependence upon the particular subject matter, an expert score representing an estimated level of expertise;
calculating, by retrieving one or more social media repositories, an impact rating for each potential subject matter expert with regard to the particular subject matter;
ranking the potential subject matter experts in dependence upon the expert score and in dependence of the impact rating assigned to each potential subject matter expert; and
returning, as one or more search results, the potential subject matter experts in order of the ranking.

2. The method of claim 1, wherein the search profile is formed by a weighted collection of topics, concepts, or topics and concepts.

3. The method of claim 2, wherein the search profile is formed by a search vector.

4. The method of claim 3, wherein the retrieving of the one or more resources comprises matching the search vector with one or more vectors of a knowledge profile including the particular subject matter.

5. The method of claim 1, wherein the impact rating includes a resonance, a reach, or the resonance and the reach of a potential subject matter expert within social media repositories.

6. The method of claim 5, wherein the resonance is determined by one or more of the following:
assessing comments in response to the potential subject matter expert;
determining an average value of ratings of the potential subject matter expert; or
determining a number of followers of the potential subject matter expert.

7. The method of claim 6, wherein the resonance is accessorily weighted by a relationship of users assessing contents of the subject matter expert, the relationship being sociometrically derived of the social media repositories.

8. The method of claim 5, wherein the reach is determined by one or both of the following:
determining a retrieval count of contents published by the potential subject matter expert; or
determining a count of re-posts including contents published by the potential subject matter expert.

9. The method of claim 1, wherein a first adjustable weight factor for the expert score and a second adjustable weight factor for the impact rating are applied for ranking the potential subject matter experts.

10. A computer program product comprising program code stored on a non-transitory computer-readable storage medium, the program code, when executed on a computer, is configured to:
receive a search profile corresponding to a particular subject matter;
retrieve, in one or more information repositories, in dependence upon the search profile, one or more resources comprising content describing the particular subject matter;
identify one or more potential subject matter experts associated with the resources;
calculate, for each potential subject matter experts, in dependence upon the particular subject matter, an expert score representing an estimated level of expertise;
calculate, by retrieving one or more social media repositories, an impact rating for each potential subject matter expert with regard to the particular subject matter;
rank the potential subject matter experts in dependence upon the expert score and in dependence of the impact rating assigned to each potential subject matter expert; and;
return, as one or more search results, the potential subject matter experts in order of the ranking.

11. The computer program product of claim 10, wherein the search profile is formed by a weighted collection of topics, concepts, or topics and concepts.

12. The computer program product of claim 11, wherein the search profile is formed by a search vector.

13. The computer program product of claim 12, wherein the retrieval of the one or more resources comprises matching the search vector with one or more vectors of a knowledge profile including the particular subject matter.

14. The computer program product of claim 10, wherein the impact rating includes a resonance, a reach, or the resonance and the reach of a potential subject matter expert within social media repositories.

15. The computer program product of claim 14, wherein the program code is further configured to determine the resonance by one or more of the following:
assess comments in response to the potential subject matter expert;
determine an average value of ratings of the potential subject matter expert; or
determine a number of followers of the potential subject matter expert.

16. The computer program product of claim 15, wherein the resonance is accessorily weighted by a relationship of users assessing contents of the subject matter expert, the relationship being sociometrically derived of the social media repositories.

17. The computer program product of claim 14, wherein the program code is further configured to determine the reach by one or both of the following:
determine a retrieval count of contents published by the potential subject matter expert; or
determine a count of re-posts including contents published by the potential subject matter expert.

18. The computer program product of claim 10, wherein a first adjustable weight factor for the expert score and a second adjustable weight factor for the impact rating are applied for ranking the potential subject matter experts.
